(19) United States
(12) Patent Application Publication
(10) Pub. No.: US 2020/0309293 A1
(43) Pub. Date: Oct. 1, 2020

(54) Twist Lock Coupling System and Method

(71) Applicant: Rodger Dale Andrew, Seagoville, TX (US)

(72) Inventor: Rodger Dale Andrew, Seagoville, TX (US)

(21) Appl. No.: 16/831,625

(22) Filed: Mar. 26, 2020

Related U.S. Application Data
(60) Provisional application No. 62/824,299, filed on Mar. 26, 2019.

(51) Int. Cl. F16L 23/00; F16L 23/08

(52) U.S. Cl. CPC F16L 23/003; F16L 23/08

(57) ABSTRACT

A slotted twist lock connector designed to accommodate existing wiring to replace a broken conduit coupling or connector. The connector features a slot passing along the length of the sleeve to accommodate wires, enabling a clamp to be threaded to the sleeve to combine the wiring slots, allowing the slots to be rotated out of alignment to lock the wires into the coupler. Advantageously, the connector allows electricians to complete the configuration in a matter of minutes compared to standard methods which may take hours at a time, offering a way to replace broken conduit couplings or connectors applied to all sizes of existing conduit and wiring.

### CROSS-REFERENCE TO RELATED APPLICATION(S)

The present application is related to and claims priority to U.S. Provisional Patent Application No. 62/824,299 filed Mar. 26, 2019, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of metal working of existing art and more specifically relates to spaced wall tubes or receptacles.

### RELATED ART

Traditional broken conduit connectors and couplings that require replacing must have electricity powered down and then the wiring removed from both ends of the conduit. The wire must be replaced and then rewired to the original circuit. Critical wiring and machinery are put at risk due to the extensive amount of time required to make the replacement/repairs. A suitable solution is desired.

U.S. Pat. No. 5,661,891 to Miller et al., relates to a method of passing wires through a firewall using telescoping conduit assembly. The described method includes a conduit assembly which has an inner sleeve and outer sleeve which are proportioned to be concentrically mounted, each of which has a longitudinal slot of approximately the same width. The conduits are circular, and a detent is provided on the larger of the conduits to accept and nestingly receive the slot of the smaller conduit when the same is rotated to form a complete circular encasement of the wires or cables which are passed through the conduits. The method of the invention contemplates the steps of forming a hole through a wall, such as a firewall, thereafter, optionally, passing the wires through, or passing the inner and outer sleeve through, and then once the wires are in place, or in anticipation of the wires being inserted, rotating the inner sleeve within the outer sleeve until the sleeve slots are approximately diametrically opposed and the central sleeve slop is secured in the detent. After the wires are in place interiorly of the conduit, a packing is inserted through the conduit assembly. Thereafter a blowout patch is secured to the exterior portion of the firewall on both side and receives the end of the conduit assembly. The blow out patch, in turn, is secured to the firewall making a complete installation in which there are voids are minimized, which voids could pass smoke, fire, fumes, or other undesirables.

### SUMMARY OF THE INVENTION

In view of the foregoing disadvantages inherent in the known metal working art, the present disclosure provides a novel twist-lock coupling system and method The general purpose of the present disclosure, which will be described subsequently in greater detail, is to provide an efficient and effective twist-lock coupling system.

A twist-lock coupling system is disclosed herein, the system comprising: a twist-lock coupling assembly including a first twist-lock coupling; a second twist-lock coupling; and a coupler having a slot. The coupler is able to move in relation to the first twist-lock coupling and the second twist-lock coupling such that electrical wires passing through the first twist-lock coupling and the second twist-lock coupling are able to be accessible and alternately not accessible depending on the rotational relationship between the coupler and the first twist-lock coupling and the second twist-lock coupling.

A method of coupling using the twist-lock coupling system is disclosed herein, the method comprising the steps of: providing the twist-lock coupling system including a twist-lock coupling assembly including a first twist-lock coupling; a second twist-lock coupling; and a coupler; cutting a conduit; repairing wiring; and installing the twist-lock coupling assembly to couple the conduit. The method may further comprise the step of rotating the coupler to access the wiring.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a twist-lock coupling system, constructed and operative according to the teachings of the present disclosure.

FIG. 1 is a perspective view of the twist-lock coupling system according to an embodiment of the disclosure.

FIG. 2 is a perspective view of the twist-lock coupling system of FIG. 1, according to an embodiment of the present disclosure.

FIG. 3 is a perspective view of the twist-lock coupling system of FIG. 1, according to an embodiment of the present disclosure.

FIG. 4 is a perspective view of the twist-lock coupling system of FIG. 1, according to an embodiment of the present disclosure.

FIG. 5 is a perspective view of the twist-lock coupling system (as installed for in-use condition) of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to coupling means and more particularly to a twist-lock coupling system as used to improve the efficiency for coupling of electrical wiring.

Generally, Twist-lock couplings are small conduit couplings each designed with a modified barrel connector and two modified conduit connectors threaded into each end. The coupler can be used as a connector or repair splice which allows access to the interior wires for servicing. The sleeve is cylindrical and includes a slot through the length. Each clamp has a similar slot to accommodate wires inserted within the coupler.

The clamps can be threaded to the sleeve, allowing wires to be placed within the coupler and the clamp to be rotated. The rotation locks the wires into the coupler, and each clamp can be tightened to secure them on either end of the electrical conduits. The clamps can be tightened with a removable bolt. Users can apply the Twist-lock coupling in a matter of minutes, saving extensive amounts of time and effort in the replacement.

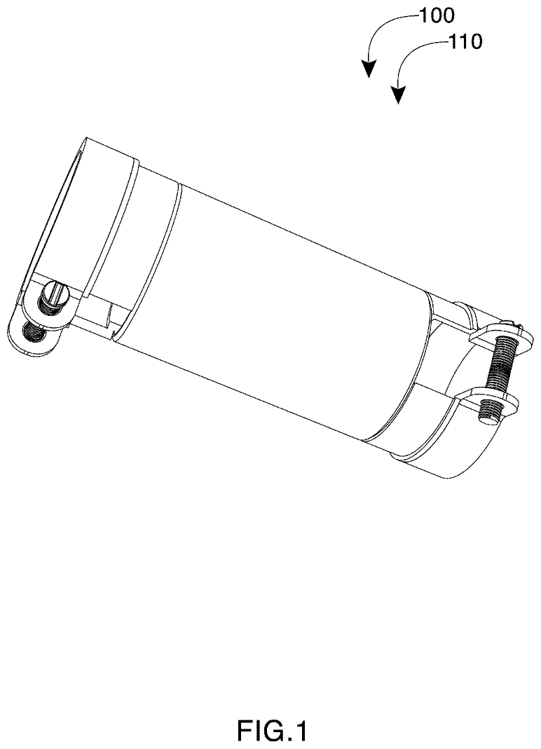

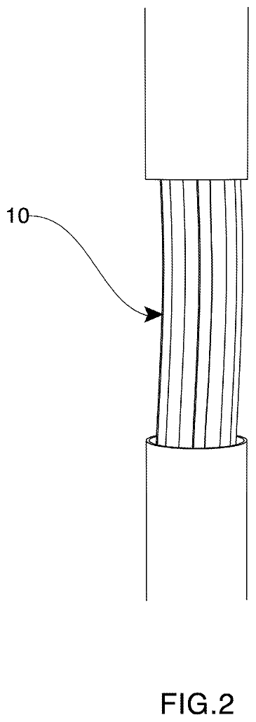

Referring now more specifically to the drawings, FIGS. 1-5 shows various views of a twist-lock coupling system.

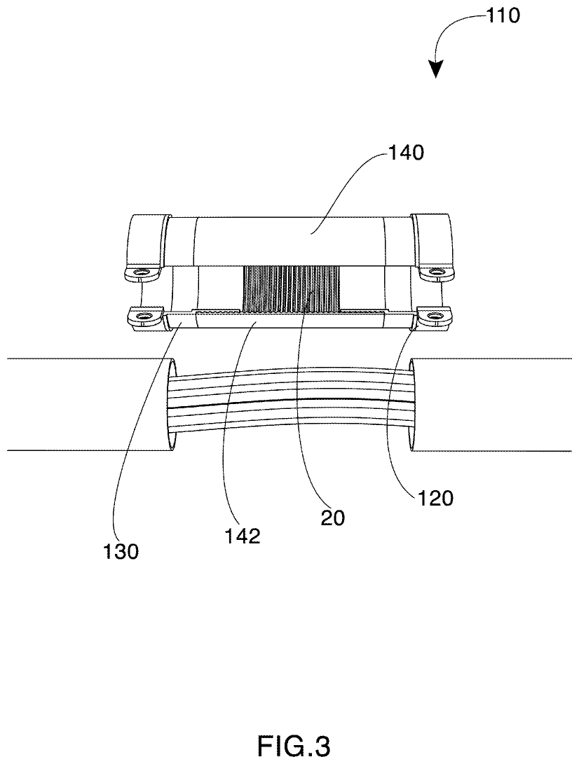

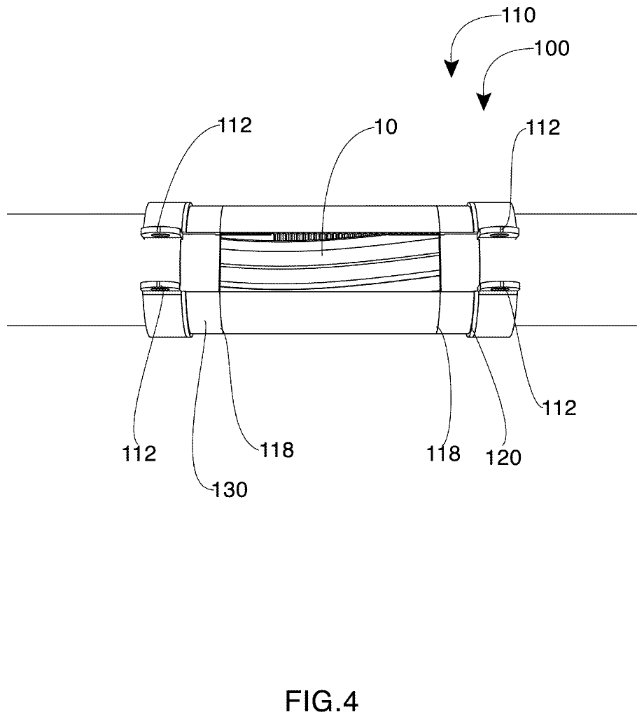

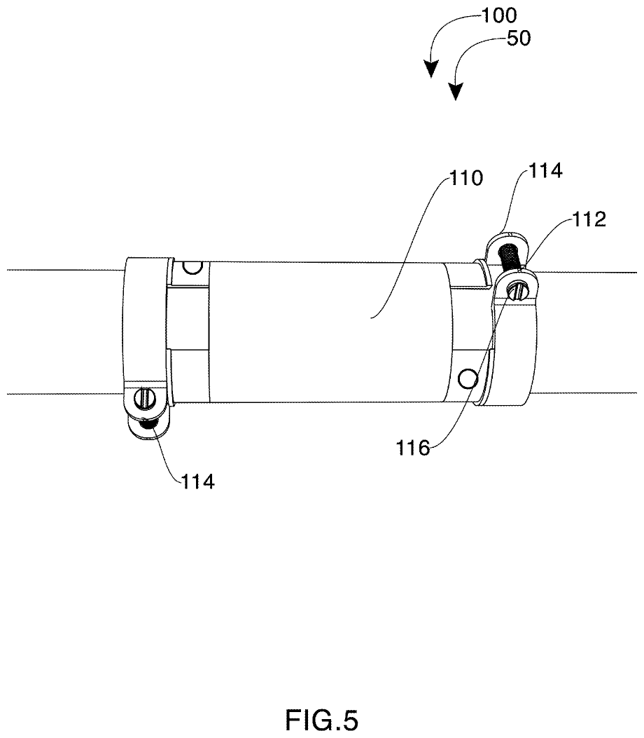

FIGS. 1-5 shows a twist-lock coupling system leading up to and during an ‘in-use’ condition 50 (FIG. 5), according to an embodiment of the present disclosure. FIG. 3 illustrates the twist-lock coupling system, which may include a twist-lock coupling assembly 110 including at least a first twist-lock coupling 120; a second twist-lock coupling 130; and a coupler 140 (having a slot 142). The coupler 140 moves (including rotationally) relative to the first twist-lock coupling 120 and the second twist-lock coupling 130 (when manually rotated) such that electrical wires 10 passing through the first twist-lock coupling 120 and the second twist-lock coupling 130 are accessible or not depending on the relative position between the coupler 140, the first twist-lock coupling 120, and the second twist-lock coupling 130. The first twist-lock coupling 120 and the second twist-lock coupling 130 rotate independently of each other. When open, slot 142 matches the openings in the first twist-lock coupling 120 and the second twist-lock coupling 130 as shown in FIGS. 3-4. FIG. 5 shows assembly 110 in the closed position. In the closed position, the wires are covered; in the open position, the wires are exposed.

FIG. 4 shows that coupler 140 has internal threads 20, which engage external threads on the first twist-lock coupling 120 and the second twist-lock coupling 130 shown in FIG. 4. The first twist-lock coupling 120 and the second twist-lock coupling 130 of the twist-lock coupling system each comprise lugs 112, which function as clamps 114 (providing clamping means) when fasteners 116, extending through or spanning lugs 112, are tightened. Fasteners 116 may comprise nuts and bolts, screws, or other suitable or equivalent fastener. In some embodiments, at least one of lugs 112 on each clamp 114 comprises internal threads to receive a bolt or a screw, etc.

The first twist-lock coupling 120 is located spaced from the second twist-lock coupling 130 during use (as shown in FIG. 4). In some embodiments, the couplings are not right against each other. The first twist-lock coupling 120 and the second twist-lock coupling 130 couple to conduit pipe as shown in FIGS. 3 & 5.

Referring now back to the coupler 140; the slot 142 runs or extends the full-length of the coupler 140. The twist-lock coupling assembly 110 is configured for use in repair via splicing as shown in FIGS. 3-5. The first twist-lock coupling 120 and the second twist-lock coupling 130 are able to be rotated independent of each other. The first twist-lock coupling 120 and the second twist-lock coupling 130 each comprise a modified conduit connector end as shown in FIG. 3. The coupler 140 is arcuate as shown in FIGS. 3-4. The first twist-lock coupling 120 and the second twist-lock coupling 130 each comprise a lip-edge 118 as shown in FIGS. 3-4. The first twist-lock coupling 120 and the second twist-lock coupling 130 maintain a distance from each other because of the coupler 140 also shown in FIGS. 3-4.

According to one embodiment, the twist-lock coupling system may be arranged as a kit. In particular, the twist-lock coupling system may further include a set of instructions. The instructions may detail functional relationships in relation to the structure of the twist-lock coupling system such that the twist-lock coupling system can be used, maintained, or the like, in a preferred manner.

A method of use may include one or more components or features of the twist-lock coupling system as described above may include the steps of: step one providing the twist-lock coupling system including a twist-lock coupling assembly including a first twist-lock coupling; a second twist-lock coupling; and a coupler; step two, cutting a conduit; step three, repairing wiring; step four, installing the twist-lock coupling assembly to couple the conduit. The method may further comprise the step five of rotating the coupler to access the wiring.

Some steps may be optional, and more steps may be added. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for use of the twist-lock coupling system are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A twist-lock coupling system, the system comprising:
a twist-lock coupling assembly including
a first twist-lock coupling;
a second twist-lock coupling;
and
a coupler having a slot,
wherein the coupler moves rotationally relative to the first twist-lock coupling and the second twist-lock coupling to expose or cover electrical wires passing through the first twist-lock coupling and the second twist-lock coupling.

2. The twist-lock coupling system of claim 1, wherein the coupler and the first and second twist-lock couplings each have threads.

3. The twist-lock coupling system of claim 2, wherein the threads on the coupler engage threads on the first and second twist-lock coupling.

4. The twist-lock coupling system of claim 1, wherein the first and second twist-lock couplings each comprise lugs and fasteners that span the lugs.

5. The twist-lock coupling system of claim 4, wherein the lugs and fasteners form a clamp.

6. The twist-lock coupling system of claim 5, wherein the fasteners are selected from bolts, nuts, and screws.

7. The twist-lock coupling system of claim 1, wherein the coupler sits between the first twist-lock coupling and the second twist-lock coupling.

8. The twist-lock coupling system of claim 1, wherein the first twist-lock coupling and the second twist-lock coupling are configured to connect conduit pipe.

9. The twist-lock coupling system of claim 6, wherein at least one of the lugs comprises internal threads to receive the fastener.

10. The twist-lock coupling system of claim 1, wherein the slot extends a full length of the coupler.

11. The twist-lock coupling system of claim 1, wherein the twist-lock coupling assembly is configured to splice conduit.

12. The twist-lock coupling system of claim 1, wherein the first twist-lock coupling and the second twist-lock coupling rotate independently of each other.

13. The twist-lock coupling system of claim 1, wherein the first twist-lock coupling and the second twist-lock coupling each comprise a modified conduit connector end.

14. The twist-lock coupling system of claim 1, wherein the coupler is arcuate.

15. The twist-lock coupling system of claim 1, wherein the first twist-lock coupling and the second twist-lock coupling each comprise a lip-edge.

16. The twist-lock coupling system of claim 1, wherein the coupler spaces the first twist-lock coupling a distance from the second twist-lock coupling.

17. A twist-lock coupling system comprising:
a twist-lock coupling assembly including
a first twist-lock coupling;
a second twist-lock coupling;
and
a coupler having a slot,
wherein the coupler moves rotationally relative to the first twist-lock coupling and the second twist-lock coupling to expose or cover electrical wires passing through the first twist-lock coupling and the second twist-lock coupling;
wherein the slot comprises a full length of the coupler;
wherein the coupler, and the first twist-lock coupling, and the second twist-lock coupling each have threads, the threads on the coupler engage the first twist-lock coupling and the second twist-lock coupling;
wherein the first and second twist-lock couplings each comprise lugs and bolts that span the lugs;
wherein the lugs and bolts form a clamp;
wherein at least one of the lugs comprises internal threads to receive the bolt;
wherein the first twist-lock coupling and the second twist-lock coupling rotate independently of each other;
and
wherein the coupler spaces the first twist-lock coupling and the second twist-lock from each other.

18. A method of coupling using the twist-lock coupling system, the method comprising the steps of:
providing the twist-lock coupling system of claim 1
cutting a conduit;
repairing wiring;
and
installing the twist-lock coupling assembly to couple the conduit.

19. The method of claim 18, further comprising the step of rotating the coupler to access the wiring.

20. The method of claim 18, wherein the first and second twist-lock couplings each comprise lugs and fasteners that span the lugs fasteners.
